(19) United States
(12) Patent Application Publication
(10) Pub. No.: US 2008/0205679 A1
(43) Pub. Date: Aug. 28, 2008

(54) In-Ear Auditory Device and Methods of Using Same

(76) Inventors: Alexander L. Darbut, Edina, MN (US); Thomas Bruce Odegard, Minneapolis, MN (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(21) Appl. No.: 11/996,138

(22) PCT Filed: Jul. 18, 2006
(86) PCT No.: PCT/US06/27619

§ 371 Date: Jan. 18, 2008

Related U.S. Application Data
(60) Provisional application No. 60/700,428, filed on Jul. 18, 2005.

(30) Foreign Application Priority Data
Jul. 18, 2005 (US) 11184604

(51) Int. Cl. H04R 25/00

(52) U.S. Cl. 381/328

(57) ABSTRACT

An in-ear auditory device and methods of using same. The in-ear auditory device has a receiver sized to fit within an ear canal of a user, a transducer and an isolator disposed to substantially acoustically isolate the transducer from the receiver. The in-ear auditory device may include a bone vibration sensor acoustically or mechanically coupled to the transducer to detect the user's speech. The in-ear auditory device can further include a physiologic sensor to sense physiologic signals of the user. In use, the in-ear auditory device is coupled to an auxiliary device having circuitry to process signals to and from the in-ear auditory device. The auxiliary device may include wireless communication circuitry to communicate signals to and from remote communication or monitoring devices.

### CROSS-REFERENCE TO RELATED APPLICATIONS

This application is a continuation-in-part of U.S. patent application Ser. No. 11/184,604 filed Jul. 18, 2005 and claims priority to Provisional Application No. 60/700,428 filed Jul. 18, 2005.

### BACKGROUND

An auditory device is any device used for listening and/or communicating sound. All auditory devices include a receiver, which converts electrical signals to acoustic signals or sound. Examples of auditory devices, include, without limitation, hearing aids; the receiver-end of a telephone handset mobile telephone or two-way radio; earphones; in-ear headphones, such as those commonly used with portable radios and digital audio players such as the iPod® or other MP3 players; over-the-ear headphones of assistive listening devices which enable the wearers to hear persons speaking despite noisy environments (e.g., the headphones worn by the flight-deck crew on aircraft carriers); and the like.

For two-way voice communication devices such as telephones (wired or wireless) and two-way radios, it is necessary to pair the receiver with a transducer/microphone, which converts sound or acoustic signals to electrical signals. Thus, for example, in a conventional land-line telephone handset, the user speaks into the end of the handset with the transducer/microphone. The sound of the speaker's voice is converted to electrical signals by the transducer/microphone. These transduced electrical signals are transmitted via wires or fiber-optics until reaching the receiver of the remote telephone handset of the other party where the electrical signals are then converted back into acoustic signals representative of the sound of the speakers voice. The same basic components and principles are the same for wireless or cellular telephone handsets and two-way radio handsets except that the signals are transmitted via radio waves instead of wires or fiber-optics.

Headsets or headphones for conventional telephones, cell phones and two-way radios have the same basic structure—the headset earpiece contains the receiver and the headset boom contains the microphone/transducer. Headsets are desirable over handsets because they are “hands-free,” enabling the user to do other things with his/her hands while communicating with others.

Consumers generally desire headsets that are comfortable to wear and unobtrusive. As a result headset manufacturers have begun producing headsets with shorter and shorter boom microphones. However, the shorter the boom-microphone is made, the closer the transducer/microphone comes to the receiver. If the microphone is placed too close to the receiver, unwanted feedback can occur because the microphone can detect vibrations from the receiver due to the close proximity between the two components.

Additionally, it should be appreciated that because the transducer/microphone within the handset or headset of the two-way communication device is generally open to the environment, the transducer/microphone will not only detect the voice of the speaker, but also any other external noises in the environment surrounding the speaker. As a result, depending on the noise level of the environment in which the user is speaking, the other party may not be able to clearly hear the speaker's voice. Accordingly, it is desirable to provide a hands-free, two-way communication device that is non-obtrusive, comfortable to wear, avoids unwanted feedback, and which minimizes external environmental noise that can interfere with clarity of the speakers voice.

It is known that when a person speaks, the person's skull, jaw, throat, ear canal and other surrounding bony and cartilaginous tissue vibrate as sound is produced. Communication devices have been developed that can detect the vibrations of the bony or cartilaginous tissue (hereinafter “bone conduction sensors”) and that can then convert these detected vibrations into electrical signals representative of the speaker's voice. However, external environmental noise may still be detected by bone conduction sensors depending on the type, configuration and location of the sensor being used, thereby interfering with clear communication of the speaker's voice.

In addition to being able to have voice communication between remote persons, it may also prove desirable to be able to remotely monitor certain physiologic conditions of a person. One particular application where remote physiologic monitoring is currently being used is in the medical field. In some hospitals and nursing home facilities, certain physiologic conditions of multiple patients can be monitored from a centralized nursing station. In addition to the medical and health care fields, other areas where remote monitoring of physiologic conditions of others may prove useful is in the military to know if a soldier is alive or seriously wounded. A similar application would be applicable in the police or firefighting profession. Another application, for example, might be in the sports field, such as football or other physically demanding sport, whereby a trainer will be able to monitor if a player's body temperature or heart rate, for example, are approaching dangerous levels.

For the foregoing reasons, it is desirable to provide a single auditory device that can cooperate with auxiliary devices to perform as a hearing aid or an assisted listening device, while at the same time being capable of performing as a communication device that is non-obtrusive, does not experience feedback, minimizes external environmental noise that can effect clarity of voice communication from the user, and, may be used to monitor one or more physiologic conditions of the wearer.

### SUMMARY

The present invention is directed toward an in-ear auditory device and methods of using the same. The in-ear auditory device has a receiver and a transducer preferably sized to fit within an ear canal of a user. An isolator is disposed to substantially acoustically isolate the transducer from the receiver. In a preferred embodiment, the in-ear auditory device includes a bone vibration sensor acoustically or mechanically coupled to the transducer to detect the user's speech. The in-ear auditory device may include a physiologic sensor to sense physiologic signals of the user.

In use, the in-ear auditory device is coupled to an auxiliary device having circuitry to process signals to and from the in-ear auditory device. The auxiliary device may include wireless communication circuitry to transmit the processed signals to remote communication and/or monitoring devices.

### BRIEF DESCRIPTION OF THE DRAWINGS

FIG. 1 is a perspective view of one embodiment of an in-ear auditory device of the present invention with an open-ear tip.

FIG. 2 is a perspective view of the in-ear auditory device of FIG. 1, but with a closed-ear tip.

FIG. 3 is an exploded perspective view of the in-ear auditory device of FIG. 1.

FIG. 4 is a cross-sectional view of the in-ear auditory device of FIG. 2 as viewed along lines 4-4 of FIG. 2.

FIG. 5 is a perspective view of another embodiment of an in-ear auditory device of the present invention.

FIG. 6 is a cross-sectional view of the in-ear auditory device of FIG. 5 as viewed along lines 6-6 of FIG. 5.

FIG. 7 is a view of a human ear with an in-ear auditory device of the present invention placed within the ear canal; the in-ear auditory device is shown coupled to a behind-the-ear (BTE) auxiliary device.

FIG. 8 is a view of the in-ear auditory device and the BTE auxiliary device of FIG. 7 as viewed along lines 8-8 of FIG. 7.

FIG. 9 is a perspective view of the in-ear auditory device of FIG. 2 coupled to a within-the-ear (WTE) auxiliary device.

FIG. 10 is an illustration showing the in-ear auditory device and WTE auxiliary device of FIG. 9 disposed within a human ear.

### DETAILED DESCRIPTION

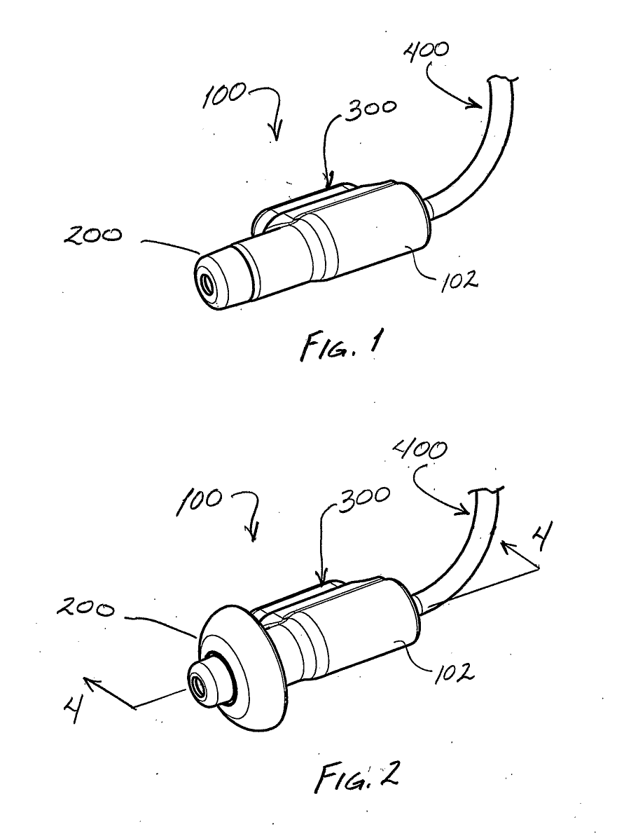

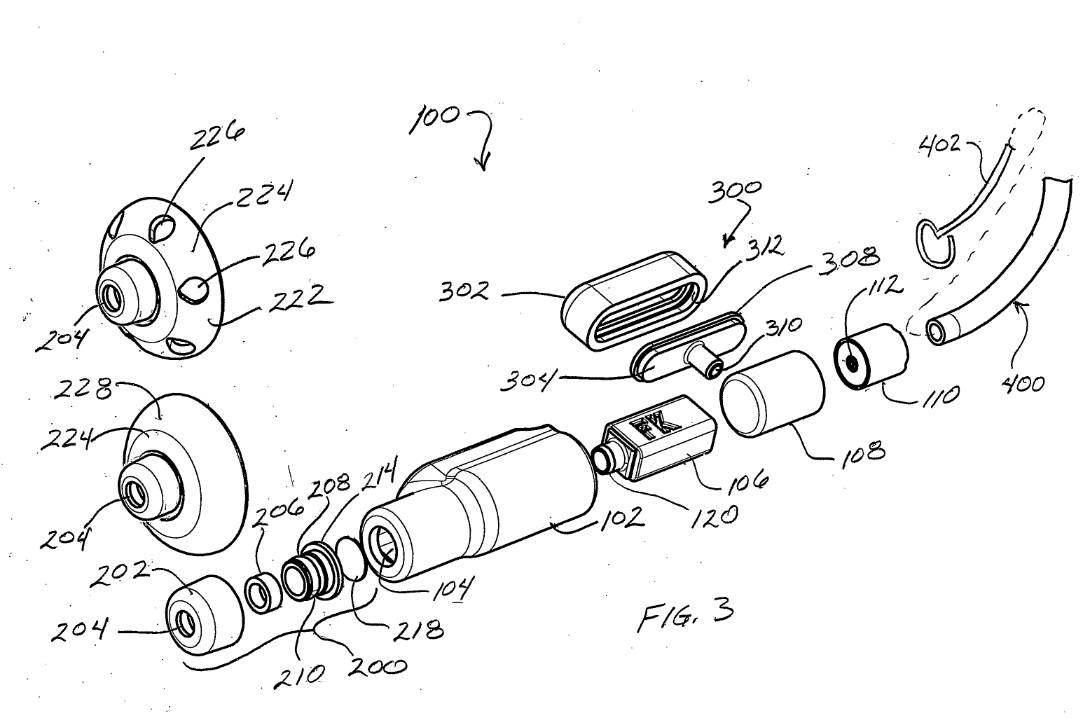

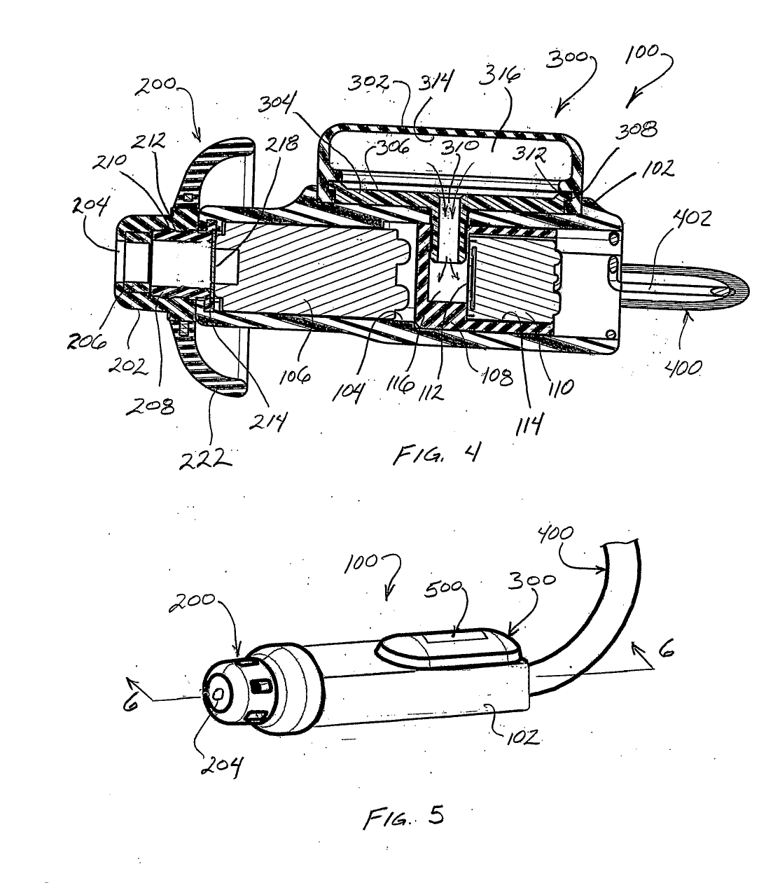

Referring now to the drawings wherein like reference numerals identify corresponding or like parts throughout the several views, FIG. 1 illustrates one embodiment of an in-ear auditory device 100 of the present invention. In this embodiment, the in-ear auditory device 100 includes a housing 102, a tip assembly 200 and, preferably, a bone conduction sensor 300. The tip assembly 200 of FIG. 1 is illustrated as an open-ear tip. In FIG. 2, the in-ear auditory device 100 is illustrated as having a closed-ear tip assembly 200. FIG. 3 is an exploded perspective view of the in-ear auditory device 100 of FIG. 1 and illustrating the interchangeability of tips 200 (discussed later). FIG. 4 is a cross-sectional view of the in-ear auditory device 100 as viewed along lines 4-4 of FIG. 2.

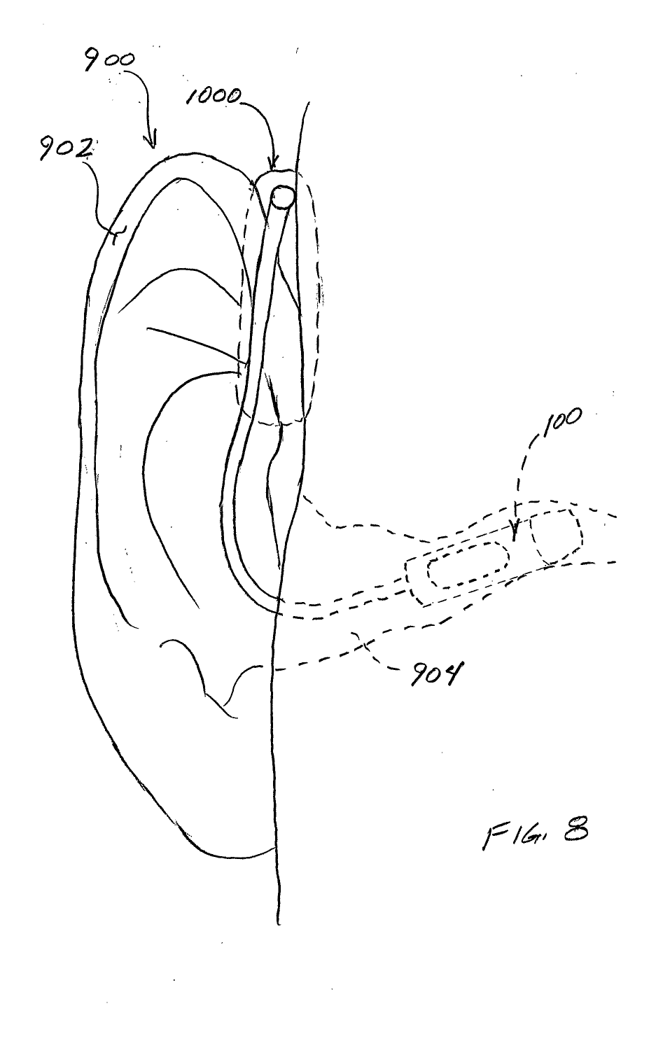

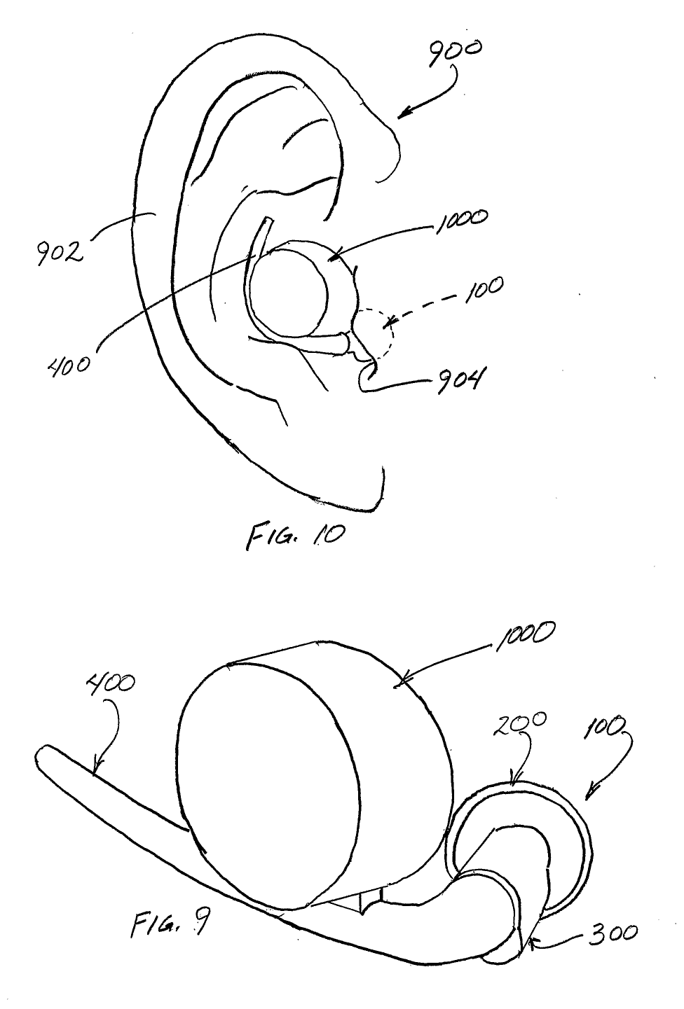

FIGS. 7-10 illustrate the in-ear auditory device 100 of the present invention in use with different types of auxiliary devices 1000. As used herein, an auxiliary device 1000 refers to any device capable processing signals to and/or from the in-ear auditory device 100 to produce one or more of the functionalities or features discussed in this specification. In FIGS. 7-8, the in-ear auditory device 100 is shown coupled to a behind-the-ear (BTE) auxiliary device 1000, such as disclosed in U.S. patent application Ser. No. 11/184,604, incorporated herein by reference. FIGS. 9-10 illustrate the in-ear auditory device 100 coupled to an auxiliary device 1000 disposed within-the-ear (“WTE”).

Referring to FIGS. 3 and 4, the housing 102 preferably includes a central through-bore 104. A receiver 106 is disposed within the through-bore 104, followed by an isolator 108 and a transducer 110. One or more channels (not shown) are formed in the sidewalls of the through-bore 104 within which wires (not shown) are disposed for carrying power (preferably provided by a DC battery source disposed in the auxiliary device 1000) and for carrying electrical signals to and from the receiver 106 and transducer 110. These wires are preferably routed through a conduit 400 that preferably couples to the auxiliary device 1000 (as illustrated in FIGS. 7 and 8) or is integral with the auxiliary device 1000 (as illustrated in FIGS. 9 and 10).

As illustrated in FIG. 4, the conduit 400 is preferably stiff to hold the in-ear device 100 in the appropriate orientation such that the bone conduction sensor 300 maintains contact with the cartilaginous portion of the ear canal 904. In the embodiment of FIGS. 3 and 4, a stainless steel wire 402 is bent into the desired shape and is fed into the conduit 400. The distal end of the wire is shaped to be retained within a groove formed in the sidewalls of the through-bore 104.

Referring to FIGS. 9 and 10, the conduit 400 is preferably integrally formed with the housing 102 of the in-ear device 100. In this embodiment, the conduit 400 preferably tapers toward the tail end. Due to the material properties and the tapered configuration, the conduit 400 has a resiliency such that when bent to fit within the pinna 902 of the user's ear, the tail end is biased against the user's ear holding the auxiliary device 1000 in place.

In the preferred embodiment, the transducer 110 is a microphone-transducer. However, a piezo-electric transducer may also be used with the present invention. The preferred microphone-transducer 110 for use in the in-ear device 100 is an FG Series available from Knowles Electronics, Itasca, Ill. A preferred receiver 106 for use in the in-ear device 100 is an FK Series also available from Knowles Electronics. It should be understood that other receivers and transducers than those specifically identified above may be equally or better suited for use in the in-ear auditory device 100 depending on its intended use or application. Thus, the present invention should not be construed as being limited to any particular type of transducer or receiver.

As best illustrated in FIG. 4, the receiver 106 and transducer 110 are preferably sized to fit within the ear canal 904 of the user and are preferably disposed substantially co-axially within the through bore 104 thereby permitting the housing 102 to have a diameter small enough to fit into the user's ear canal 904 as best illustrated in FIGS. 7, 8 and 10. The housing 102 is preferably made of suitable bio-compatible material such as silicone or like material having similar bio-compatibility qualities. The housing 102 may be molded in halves and secured together by mechanical means or bonded together by an adhesive or other welding process recognized by those of skill in the art. Alternatively, the housing 102 and the isolator 108 may be formed together as a single unit with the same or different materials by an injection or insert molding process or any other suitable fabrication process. Thus, rather than a through-bore, separate bores from either end may be drilled or formed into the housing 102 into which the receiver 106 and transducer 110 are inserted, respectively. Obviously many different housing configurations, materials and fabrication methods may be suitable for providing a housing. Accordingly, the present invention should not be construed as being limited to any particular type of material, housing configuration, or fabrication method.

In the preferred embodiment, the microphone-transducer 110 has an input port 112 that is received within a bore 114 (FIG. 4) in one end of the isolator 108. The isolator 108 is preferably formed of silicone or other viscoelastic material. Viscoelastic materials generally exhibit stress/strain behavior that is time-rate dependent and varies by material. The stress/strain behavior is a function of the material's internal friction. Viscoelastic materials are stiffer and stronger at high strain rates than at low strain rates. As a result, viscoelastic materials are flexible with respect to relatively small forces, such as sound vibrations produced by the receiver 106. Hence, the isolator 108 dampens the sound frequency vibrations produced by the receiver 106 such that the vibrations are not transferred to the transducer 110. As such, the transducer 110 is substantially acoustically isolated from the receiver 106, thereby minimizing feedback effects. In addition, electronic feedback control/echo canceling may also be utilized to achieve acoustic isolation of the transducer 110. Thus, as used herein, acoustic isolation should be understood as including physical dampening of vibrations, electronic feedback control/echo canceling, or a combination of thereof. The isolator 108 includes a chamber 116, the purpose of which is discussed below in connection with the bone conduction sensor 300.

As previously identified, when a person speaks, the bony or cartilaginous portion of his/her ear canal 904 vibrates. The bone conduction sensor 300 cooperates with the microphone-transducer 110 to detect these vibrations. FIG. 7 illustrates a human ear 900 which includes the pinna 902 (i.e., is the visible part of the ear that resides outside of the head) and the ear canal 904. FIG. 8 shows the in-ear auditory device 100 as viewed along lines 8-8 of FIG. 7. In use, as best illustrated in FIG. 8, the in-ear auditory device 100 is preferably positioned within the ear canal 904 with the tip 200 of the in-ear device 100 oriented toward the user's ear drum (not shown). The in-ear device 100 is also preferably oriented within the ear canal 904 so that the bone conduction sensor 300 is in contact with the bony or cartilaginous portion of the ear canal 904 to detect the vibrations produced when the user speaks as previously identified.

Referring to FIGS. 3 and 4, the bone conduction sensor 300 is supported by the housing 102. The bone conduction sensor 300 preferably includes a flexible domed pad 302 that projects a distance outwardly from the exterior surface of the housing 102. The flexible domed pad 302 is preferably fabricated from silicon or other suitable and bio-compatible material. The pad 302 is preferably elongated to provide a longer surface area for detecting vibrations of the bony or cartilaginous portion of the ear canal 904 with which it is placed in contact during use.

The bone conduction sensor 300 also preferably includes a rigid base 304, preferably fabricated from Acrylonitrile butadiene styrene (ABS) or other suitable thermoplastic material. The rigid base 304 has an upper surface area 306 (FIG. 4) defined by an outer periphery 308. An acoustic port 310 extends through the surface area 306. As best illustrated in FIG. 4, the flexible pad 302 has a periphery 312 and preferably a convex shaped internal surface 314. The outer periphery 308 of the base 304 is preferably sealed to the periphery 312 of the pad 302, thereby defining a substantially sealed interior volume 316 to which the acoustic port 310 is in communication.

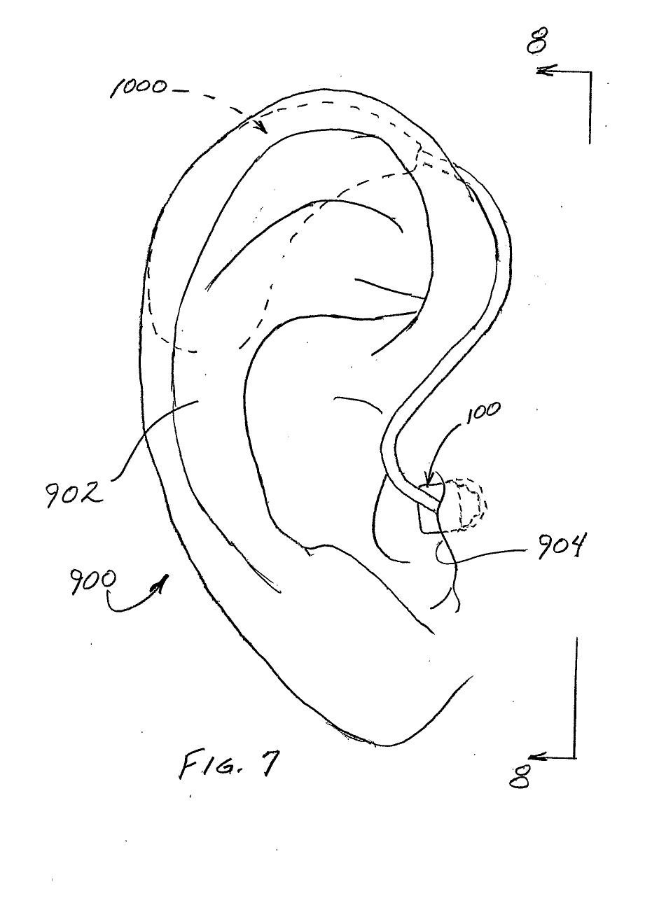

In use, when the wearer of the device 100 speaks, the vibration of the bony/cartilaginous portion of the ear canal 904 is transferred to the domed pad 302. As the pad 302 is compressed toward the base 304 by the vibrations, air is pushed out the acoustic port 310. It should be appreciated that by concentrating small amplitude vibrations over the entire area of the pad 302 into the relatively small acoustic port 310, the acoustic vibrations are amplified. As such, the flexible domed pad 302, rigid base 304, and acoustic port 310 cooperate to amplify sound much like a stethoscope. The amplified sound is routed to the microphone-transducer 110 via the acoustic port 310. The microphone-transducer 110 converts the amplified vibrations to electrical signals. These electrical signals are carried from the electrically conductive conduit 108 to the auxiliary auditory device 1000 to which it is coupled, such as, for example, the BTE device positioned behind the wearer's ear 900 (FIGS. 6 and 7).

In an alternative embodiment, rather than micro-phone transducer, a piezo-electric transducer may be provided. The substantially same configuration of the bone-conduction sensor may be utilized as described above with respect to the microphone-transducer, but instead of the transducer and bone-conduction sensor being acoustically coupled through the chamber 116, the piezo-electric transducer may be mechanically coupled with the pad 302. Vibrations may be physically transferred from the pad 302 to the piezo-electric transducer to generate electrical signals representative of the user's speech.

Referring to FIGS. 1, 2 and 3, the tip assembly 200 can have a variety of different configurations depending on acoustic properties desired and other factors. For example, the tip assembly 200 can be an open-ear configuration, such as shown in FIG. 1 of a closed-ear configuration as shown in FIG. 2. A closed-ear configuration means that the tip assembly 200 completely occludes the ear canal 904. An open-ear configuration means that there is an open path within the ear canal 904 from the ear drum past the in-ear device 100 to the external environment.

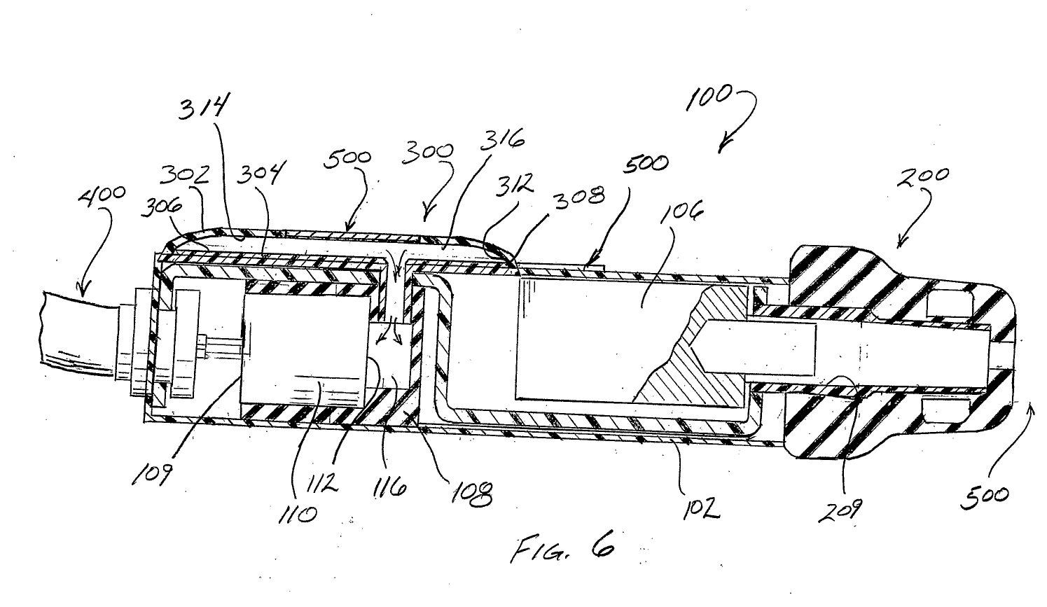

An exploded perspective view of a preferred tip assembly 200 is shown in FIG. 3. As discussed later, the preferred tip assembly 200 includes interchangeable nose pieces and interchangeable bell pieces to enable the user to change the in-ear device 100 from an open ear configuration to different closed ear configurations. The preferred tip assembly 200 includes a nose 202 having a central bore 204. The nose 200 may have radially spaced openings 205 (FIG. 5) for different acoustical effects. An annular wax guard 206 is co-axially disposed within the nose 202. An annular snout 208 has a ribbed exterior periphery 210 adapted to mate with a complimentary ribbed interior periphery 212 (FIG. 4) portion of the central bore 204 of the nose 202. The snout 208 has an annular flange 214 that fits within a complimentary groove 216 (FIG. 4) in the wall of the through-bore 104 of the housing 102. A water barrier screen 218 is coaxially disposed within the through-bore 104 adjacent the flanged end of the snout 208 and adjacent the output port 209 of the receiver 106.

If the user desires a closed-ear tip configuration as opposed to an open-ear tip configuration, a belled nose may be selected. If the user desires to only partially occlude the ear canal 904, he/she may select a belled nose 222 having a wall 224 with one or more apertures 226. If the user desires to completely occlude the ear canal 904, the user could select a belled nose 228 having a wall 224 with no apertures. Obviously many tip configurations are possible, and therefore the present invention should not be construed as being limited to any particular type of tip assembly.

FIGS. 5 and 6 illustrate an alternative embodiment of the in-ear auditory device 100. As with the other embodiment, the device 100 includes a housing 102, tip assembly 200, and preferably a bone conduction sensor 300. However, rather than the housing 102 supporting the tip assembly 200 and the bone conduction sensor 300, an S-shaped bracket 103 supports these components as well as the receiver 106, isolator 108 and transducer 110. The bracket is preferably substantially rigid and may be made from any suitable material, including steel, polycarbonate, ABS, etc. A more simplified tip assembly 200 is illustrated in FIG. 6 wherein the tip 200 is shown as comprising only a nose 202 that fits over the output port 120 of the receiver 106.

FIG. 6 also illustrate an in-ear device 100 that incorporates one or more physiologic sensors 500 such as a temperature sensor, a sensor that can detect the user's pulse, a sensor that can detect oxygen in the blood, etc. These physiologic sensors 500 may be formed integral with or secured to the housing 102 or the pad 302 of the bone conduction sensor 300. Depending on the physiologic characteristics to be sensed, the sensors 500 may or may not need to be in contact with the walls of the ear canal 904. If contact with the ear canal 904 is necessary for the sensor to sense a particular physiologic characteristic, the sensor may be oriented with respect to the housing 102 as necessary.

The sensors 500 are preferably electrically coupled via wires to the auxiliary device 1000 for processing of the physiologic signals sensed. For example, the auxiliary device 1000 may include a microprocessor and other circuitry along with software or firmware for processing the physiologic data received to determine, for example, body temperature of the user, the user's heart rate, blood pressure, pulse oximetry, etc. The auxiliary device 1000 may be programmed to trigger an audible alarm or provide other means of notifying the user if his/her body temperature rises above a predefined temperature, indicating that he/she has a fever, and/or to alert the wearer if his/her heart rate is irregular and/or above a certain maximum preselected heart rate, for example. In addition to the specific sensor applications identified above, it should be appreciated that are numerous other medical applications for the foregoing in-ear device 100 incorporating physiologic sensors 500.

Furthermore, in addition to providing information to the wearer of the device 100, by incorporating Bluetooth® or other wireless communication technology into the auxiliary device to which the in-ear device 100 is coupled, the physiologic data about the user may be communicated to a separate or remote communication device, such as, for example, a computer or other data collection device.

The foregoing description is presented to enable one of ordinary skill in the art to make and use the invention and is provided in the context of a patent application and its requirements. Various modification to the preferred embodiment of the apparatus and its method of use and the general principles and features described herein will be readily apparent to those of skill in the art. Thus, the present invention is not to be limited to the embodiments of the apparatus and methods described above and illustrated in the drawing figures, but is to be accorded the widest scope consistent with the spirit and scope of the appended claims.

1. An in-ear auditory device, comprising:
(a) a receiver sized to fit within an ear canal of a user;
(b) a transducer;
(c) an isolator to dampen vibration of said transducer.

2. The in-ear auditory device of claim 1 wherein said isolator substantially acoustically isolates said transducer from said receiver.

3. The in-ear auditory device of claim 2 wherein said isolator comprises viscoelastic material.

4. The in-ear auditory device of claim 1 wherein said transducer is a microphone.

5. The in-ear auditory device of claim 4 further comprising a bone conduction sensor acoustically coupled to said microphone.

6. The in-ear auditory device of claim 1 further comprising a bone conduction sensor mechanically coupled to said transducer.

7. The in-ear auditory device of claim 5 wherein said bone conduction sensor includes a flexible membrane having an exterior surface and an at least partially concave interior surface.

8. The in-ear auditory device of claim 7 wherein said bone conduction sensor further comprises a substantially rigid plate having an outer periphery defining an upper surface area, an acoustic outlet port disposed through said plate, said flexible membrane sealed to said plate about said outer periphery, thereby defining an interior volume between said at least partially concave interior surface of said flexible membrane and said upper surface area of said plate.

9. The in-ear auditory device of claim 8 wherein said acoustic outlet port and said microphone are acoustically coupled.

10. The in-ear auditory device of claim 9 wherein one end of said isolator includes a chamber.

11. The in-ear auditory device of claim 10, wherein an acoustic inlet port of said microphone is received within said chamber.

12. The in-ear auditory device of claim 11, wherein said acoustic outlet port of said bone conduction sensor is in communication with said chamber and said inlet port of said microphone.

13. The in-ear auditory device of claim 5 wherein said microphone and said receiver are coupled to an auxiliary auditory device having signal processing circuitry to process signals from said microphone and to said receiver.

14. The in-ear auditory device of claim 13 wherein said coupled auxiliary auditory device is disposed behind said user's pinna.

15. The in-ear auditory device of claim 13 wherein said coupled auxiliary auditory device is disposed within said user's pinna.

16. The in-ear auditory device of claim 13 further comprising a physiologic sensor disposed in relation to said receiver such that when said in-ear auditory device is inserted within said user's ear canal, said physiologic sensor senses physiologic signals.

17. The in-ear auditory device of claim 16 wherein said physiologic sensor is coupled to said auxiliary auditory device having physiologic signal processing circuitry to process said physiologic signals from said physiologic sensor.

18. The in-ear auditory device of claim 17 wherein said physiologic sensor and said physiologic signal processing circuitry monitor said user's temperature.

19. The in-ear auditory device of claim 17 wherein said physiologic sensor and said physiologic signal processing circuitry monitor said user's heart rate.

20. The in-ear auditory device of claim 17 wherein said physiologic sensor and said physiologic signal processing circuitry monitor said user's blood pressure.

21. The in-ear auditory device of claim 17 wherein said physiologic sensor and said physiologic signal processing circuitry monitor said user's pulse oximetry.

22. The in-ear auditory device of claim 13 wherein said auxiliary auditory device further includes wireless communication circuitry, whereby said wireless communication circuitry transmits said processed signals to a remote device.

23. The in-ear auditory device of claim 17 wherein said auxiliary auditory device further includes wireless communication circuitry, whereby said wireless communication circuitry transmits said processed physiologic signals to a remote device.

24. A method of communicating with a person, said method comprising:
(a) providing an in-ear auditory device to a user with whom communication is desired, said in-ear auditory comprising:
(i) a receiver sized to fit within an ear canal of said user;
(ii) a transducer;
(iii) an isolator disposed to dampen vibration of said transducer;
(b) inserting at least a portion of said in-ear auditory device within said user's ear canal;
(c) coupling said in-ear auditory device to an auxiliary auditory device, said auxiliary auditory device having signal processing circuitry to process signals from said transducer and to said receiver, said auxiliary auditory device further having wireless communication circuitry;
(d) communicating said processed signals between said auxiliary device and a remote device via said wireless communication circuitry.

25. The method of claim 24 wherein said isolator substantially acoustically dampens said transducer from said receiver.

26. The method of claim 24 wherein said isolator comprises viscoelastic material.

27. The method of claim 24 wherein said transducer is a microphone.

28. The method of claim 24 wherein said in-ear auditory device further includes a bone conduction sensor acoustically coupled to said microphone.

29. The method of claim 24 wherein said in-ear auditory device further includes a bone conduction sensor mechanically coupled to said transducer.

30. The method of claim 28 wherein said bone conduction sensor includes a flexible membrane having an exterior surface and an at least partially concave interior surface.

31. The method of claim 30 wherein said bone conduction sensor further comprises a substantially rigid plate having an outer periphery defining an upper surface area, an acoustic outlet port disposed through said plate, said flexible membrane sealed to said plate about said outer periphery, thereby defining an interior volume between said at least partially concave interior surface of said flexible membrane and said upper surface area of said plate.

32. The method of claim 31 wherein said acoustic outlet port and said microphone are acoustically coupled.

33. The method of claim 32 wherein one end of said isolator includes a chamber.

34. The method of claim 33 wherein an acoustic inlet port of said microphone is received within said chamber.

35. The method of claim 34 wherein said acoustic outlet port of said bone conduction sensor is in communication with said chamber and said inlet port of said microphone.

36. The in-ear auditory device of claim 24 wherein said coupled auxiliary auditory device is disposed behind said user's pinna.

37. The method of claim 24 wherein said coupled auxiliary auditory device is disposed within said user's pinna.

38. The method of claim 28 wherein said in-ear auditory device further includes a physiologic sensor, such that when said in-ear auditory device is inserted within said user's ear canal, said physiologic sensor senses physiologic signals.

39. The method of claim 38 wherein said physiologic sensor is coupled to said auxiliary auditory device, said auxiliary auditory device having physiologic signal processing circuitry to process said physiologic signals received from said physiologic sensor.

40. The method of claim 39 further comprising communicating said processed physiologic signals between said auxiliary auditory device and said remote device.

41. The method of claim 40 wherein said processed physiologic signals include said user's temperature.

42. The method of claim 40 wherein said processed physiologic signals include said user's heart rate.

43. The method of claim 40 wherein said processed physiologic signals include said user's blood pressure.

44. The method of claim 40 wherein said processed physiologic signals include said user's pulse oximetry.
